(19) United States
(12) Patent Application Publication
(10) Pub. No.: US 2014/0095373 A1
(43) Pub. Date: Apr. 3, 2014

(54) SUPPLY CHAIN FINANCIAL ORCHESTRATION SYSTEM WITH CONFIGURABLE TRANSFER PRICING RULES

(71) Applicant: Oracle International Corporation, Redwood Shores, CA (US)

(72) Inventors: Karthik NATARAJAN, Bangalore (IN); Shyam Sundar SANTHANAM, Redwood City, CA (US); Kalyani MANDA, Hyderabad (IN); Balaji DUVARAGAMANI, Hyderabad (IN); Prabha SESHADRI, San Jose, CA (US)

(73) Assignee: Oracle International Corporation, Redwood Shores, CA (US)

(21) Appl. No.: 14/034,683

(22) Filed: Sep. 24, 2013

Related U.S. Application Data
(60) Provisional application No. 61/707,630, filed on Sep. 28, 2012.

(51) Int. Cl. G06Q 40/04

(52) U.S. Cl. CPC G06Q 40/04
USPC 705/37

(57) ABSTRACT

A system is provided that determines a transfer price based on a transfer pricing rule. The system receives a request to calculate a transfer price for a transaction between a first entity and a second entity of a supply chain financial orchestration flow, where the supply chain financial orchestration flow defines a trade relationship between the first entity and the second entity. The system further receives transaction information associated with the transaction. The system further selects a transfer pricing rule from a plurality of transfer pricing rules, where the transfer pricing rule defines a rule to calculate a transfer price. The system further calculates the transfer price for the transaction based on the received transaction information and the selected transfer pricing rule. The system further provides the transfer price.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis. Unlike external transactions, internal trades or transfers are not market-driven. Thus, a transfer price for the internal trade is typically calculated, using methods such as a “cost-plus” method, a comparable uncontrolled price method, a resale price method, a profit split method, etc. Because a transfer price determines the allocation of profit and loss among different entities of a company, and the different entities of the company may fall into different tax regimes, many jurisdictions have implemented transfer pricing regulations and enforcements. This has made transfer pricing a major tax compliance issue for large multi-national companies.

### SUMMARY

One embodiment is a system that determines a transfer price based on a transfer pricing rule. The system receives a request to calculate a transfer price for a transaction between a first entity and a second entity of a supply chain financial orchestration flow, where the supply chain financial orchestration flow defines a trade relationship between the first entity and the second entity. The system further receives transaction information associated with the transaction. The system further selects a transfer pricing rule from a plurality of transfer pricing rules, where the transfer pricing rule defines a rule to calculate a transfer price. The system further calculates the transfer price for the transaction based on the received transaction information and the selected transfer pricing rule. The system further provides the transfer price.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates an example user interface for creating a transfer pricing rule, according to an embodiment of the invention.

FIG. 5 illustrates another example user interface for creating a transfer pricing rule, according to an embodiment of the invention.

FIG. 6 illustrates an example user interface for selecting a transfer pricing rule from an external pricing system, according to an embodiment of the invention.

FIG. 7 illustrates a block diagram of a calculate transfer price service, according to an embodiment of the invention.

FIG. 8 illustrates a flow diagram of the functionality of a supply chain financial orchestration transfer pricing module, according to an embodiment of the invention.

### DETAILED DESCRIPTION

According to an embodiment, a supply chain financial orchestration system is provided that can configure one or more transfer pricing rules pertaining to calculation of a transfer price for an internal transaction. A transfer price is a price at which one internal entity transacts with another internal entity for a sale or transfer of goods, service assets, or funds. For example, goods and/or services from one division of a business may be sold to another division, or goods and/or services from a parent company may be sold to a foreign subsidiary. The transfer price determines the allocation of profit and loss among different parts of an enterprise which may fall into different tax regimes. Given the importance of transfer price determination, the supply chain financial orchestration system can provide a “one-stop” setup to configure all the rules pertaining to the calculation of transfer price for both accounting and taxation purposes. This setup allows a user to configure multiple transfer pricing rules from a variety of available options, where a transfer pricing rule is a rule for automatically calculating a transfer price for an internal transaction based on information associated with the transaction (i.e., transaction information). The transfer pricing rules can subsequently be associated with buy and sell terms defined between specific internal entities. Once the transfer pricing rules have been associated with the buy and sell terms, the transfer pricing rules can be used to automatically calculate a transfer price for an internal transaction of a supply chain financial orchestration flow.

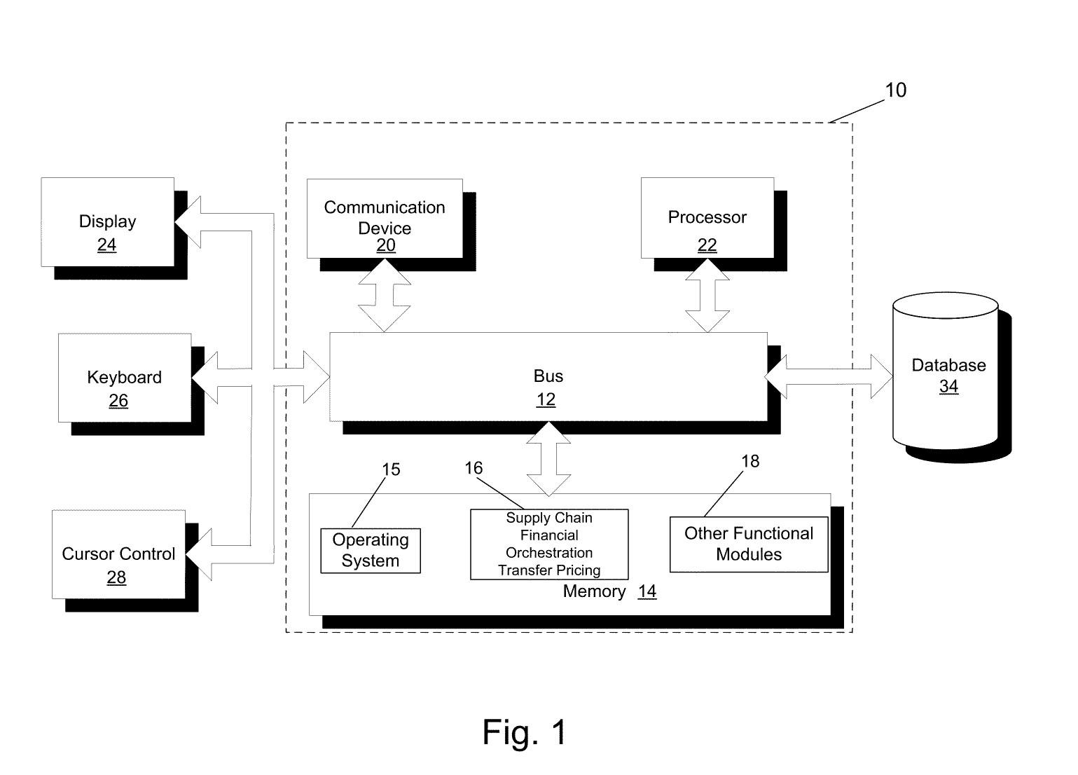

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration transfer pricing module 16, as well as other functional modules 18. Operating system 15 can provide an operating system functionality for supply chain financial orchestration system 10. Supply chain financial orchestration transfer pricing module 16 can provide functionality for calculating a transfer price based on a transfer pricing rule, as is described in more detail below. In certain embodiments, supply chain financial orchestration transfer pricing module 16 can comprise a plurality of modules that each provide specific individual functionality for calculating a transfer price based on a transfer pricing rule. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as one orm ore “Oracle Fusion Applications” from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

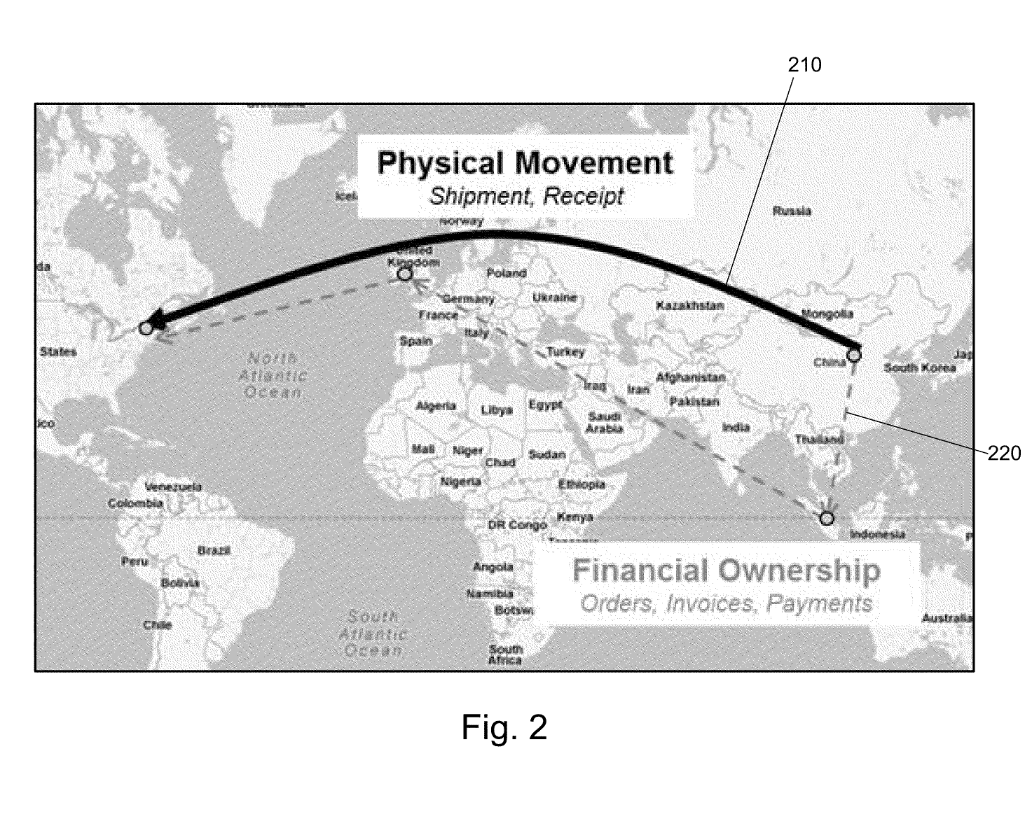

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in association with the change in financial ownership of the items (such as orders, invoices, payments, etc.). As illustrated in FIG. 2, a physical movement flow can be separate and independent of a financial flow within a supply chain financial orchestration system.

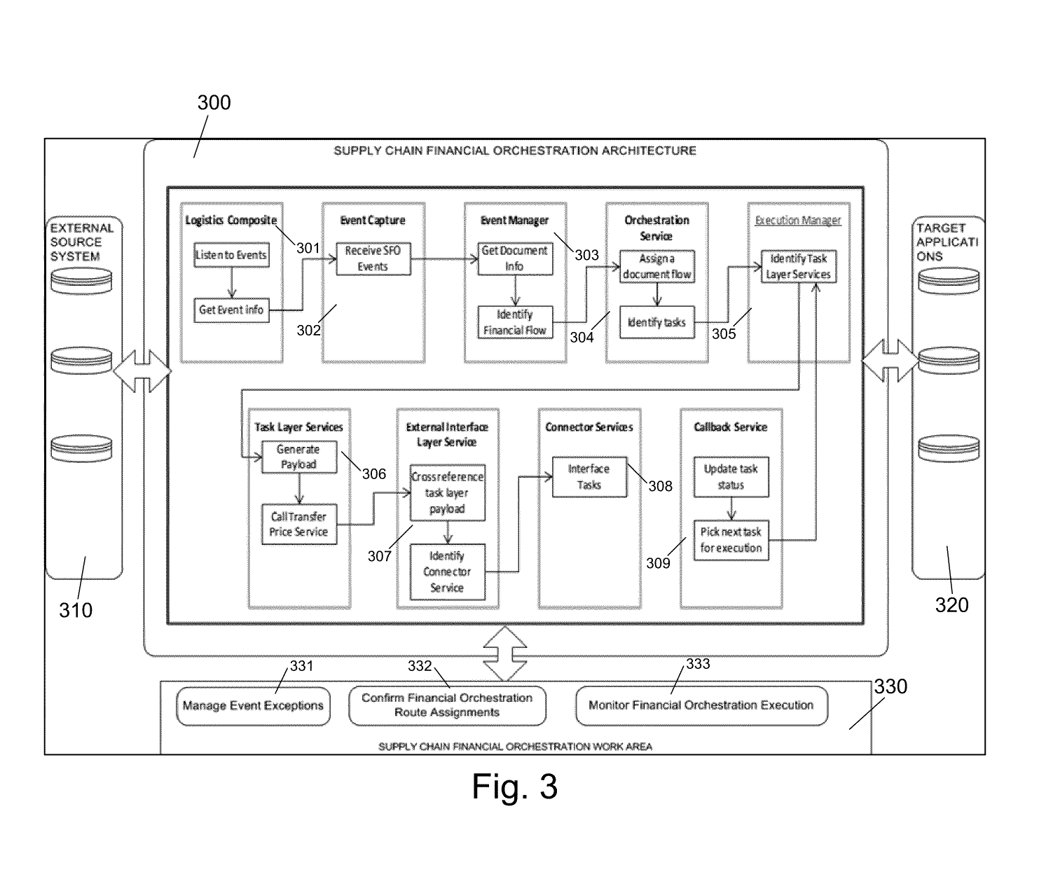

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentations required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external source system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Confirm financial orchestration route assignments 332 is a user interface that allows a user to confirm a supply chain financial orchestration flow before the tasks of the supply chain financial orchestration flow are initiated by orchestration service 304. Monitor financial orchestration execution 333 is a user interface that allows user to monitor supply chain financial orchestration flows that are in progress, that have not started, and that have completed.

In one embodiment, a supply chain financial orchestration system can have the capability of defining rules for a financial route selection by providing a qualifier rule. The qualifier rule can be evaluated, and can provide a highest priority financial route for the supply chain financial orchestration system. More specifically, an agreement that is defined by a user can define a financial route along with one or more buy/sell terms, one or more pricing rules, and/or one or more documentation and accounting rules to be used for an internal transactions. A user may wish to identify a suitable agreement based on different business parameters, such as supplier, item category, entity, etc. For example, a user may wish to use “Agreement A” for item category “Electronics” and “Agreement B” for item category “Machinery.” Thus, these business parameters can act as qualifiers for agreement identification. According to the embodiment, a qualifier rule can be defined and attached to an agreement. During an execution of a supply chain financial orchestration flow, one or more agreements that are defined for a pair of buying and selling entities of a transaction can be identified, and the one or more qualifier rules attached to the one or more identified agreements can be evaluated, and the appropriate agreement to be used for the transaction can be identified and selected. Without qualifier rules, it can be very difficult to identify an agreement for different combinations of business parameters, and it could require the customization of the source code, including “hard-coding” the agreement usage for different set of business parameters. Qualifier rules can make the process of associating an agreement with a supply chain financial orchestration flow easier.

Additionally, in one embodiment, a supply chain financial orchestration system can orchestrate tasks of a supply chain financial orchestration flow based on a defined date effective setup (i.e., a defined effective start date and a defined effective end date). More specifically, different objects (such as transfer pricing rules or tasks) can be defined in a date effective manner (i.e., defined with an effective start date and an effective end date) within an agreement. A modification to the object (e.g., transfer pricing rule or task) can be made independently for any particular date range without affecting the other objects. Once setup data is identified for a source document, the same setup data can be used for the events arising for that source document, irrespective of the changes made to the setup data after the first event arrival.

For example, when a trigger event arises, an appropriate agreement and tasks for the agreement can be identified for a specified date associated with the event within a table, as shown below:

| Task Name | Effective Start Date | Effective End Date |
|---|---|---|
| T1 | 01-Jan-2010 | 31-Dec-2012 |
| T2 | 01-Jan-2010 | 31-Dec-2012 |
| T3 | 01-Jan-2010 | 31-Dec-2012 |

In the example, an event can be received with a date of “01-Feb-2010” for a purchase order document, “PO111.” The tasks to be performed are tasks T1, T2, and T3. As shown above, one or more entries can be made in the table for a source document, and the effective date can be used for identifying the tasks. The effective date can then be used to identify the tasks when further events are triggered for that source document. This can ensure that when a setup is changed, future events for the source document will use the already-identified effective date, select the tasks corresponding to the appropriate date range that includes the effective date, and orchestrate the tasks.

In the above example, if an entity needs to additionally perform task T0 for new purchase order documents created in 2011 and onwards, but continue to only perform tasks T1, T2, and T3 for older purchase order documents created in 2010 or earlier, the table can be modified as follows:

| Task Name | Effective Start Date | Effective End Date |
|---|---|---|
| T0 | 01-Jan-2011 | 31-Dec-2012 |
| T1 | 01-Jan-2010 | 31-Dec-2012 |
| T2 | 01-Jan-2010 | 31-Dec-2012 |
| T3 | 01-Jan-2010 | 31-Dec-2012 |

When another event is received for the purchase order document, “PO111,” on Feb. 1, 2011, the supply chain financial orchestration system can refer to the previous entry that was made for the purchase order document, “PO111,” select the effective date as “01-Feb-2010,” and only perform the tasks T1, T2, and T3. If an event is received for a new purchase order document, “PO222,” on Feb. 1, 2011, then tasks T0, T1, T2, and T3 can be performed. Further, one or more task layer services that prepare a payload can also refer to the effective date indicated in the table, and select the data for the appropriate date range. Thus, a date effectivity feature can assist a user in adding or removing transfer pricing rules or tasks for any given date range. Without this feature, it is very difficult for a user to specify different sets of transfer pricing rules and/or tasks for an agreement with different date ranges. Thus, the date effectivity feature can help a user configure a setup in accordance with modifications to business requirements.

Further, in one embodiment, a supply chain financial orchestration system can provide objects (such as transfer pricing rules or tasks) with both date effectivity and multiple language support (“MLS”). Thus, the supply chain financial orchestration system can enable a user to create multi-lingual objects that also extend the date effectivity behavior previously described. By extending the date effectivity behavior into MLS-enabled attributes, the supply chain financial orchestration system can keep track of modifications to MLS-enabled attributes. The supply chain financial orchestration system can enable support for date effective operations, such as “Create,” “Retrieve,” “Insert,” “Correct,” “End Date,” and “Delete,” as well as operations, such as import and export of setup data between systems. By utilizing this framework, a user can enable date effective behavior for MLS entities. Without this framework, a user would likely have to manually create source code to support date effective operations for translatable attributes, or would have to drop either the date effectivity behavior or the MLS-enabled attributes.

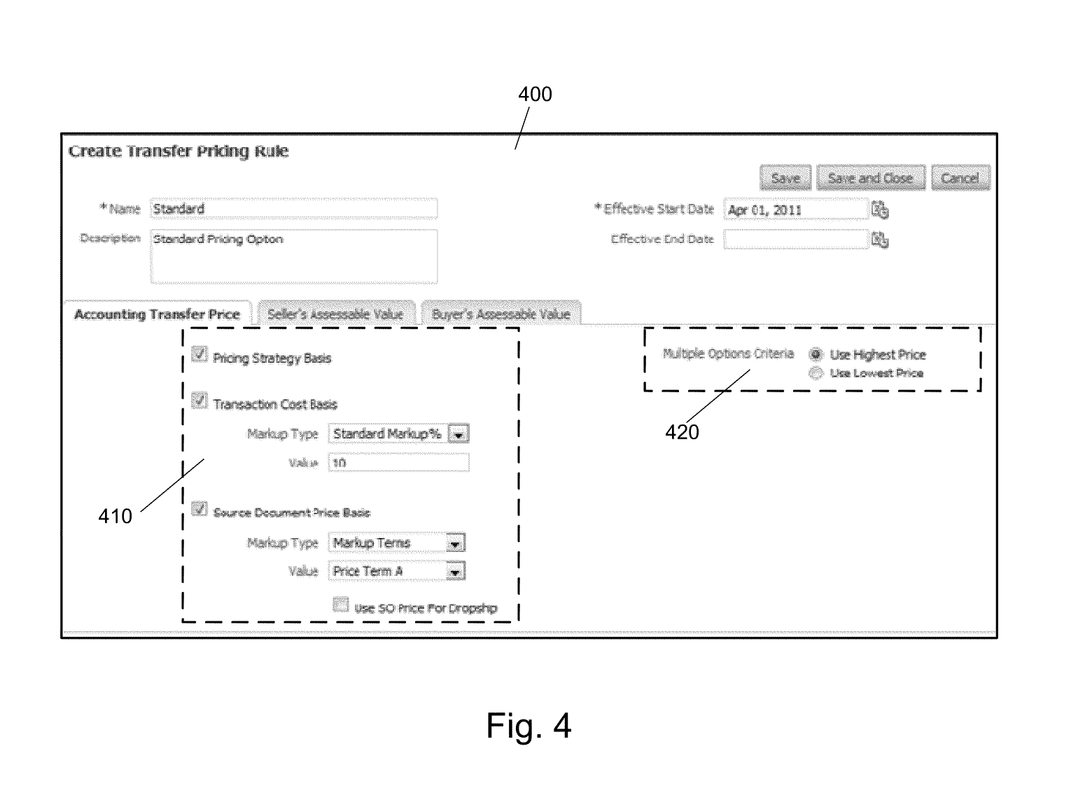

FIG. 4 illustrates an example user interface 400 for creating a transfer pricing rule, according to an embodiment of the invention. According to the embodiment, user interface 400 includes transfer pricing rule options 410, where transfer pricing rule options 410 include one or more options for defining a transfer pricing rule.

One option for defining a transfer pricing rule is a pricing strategy-based transfer price option that defines a pricing strategy-based transfer pricing rule. A pricing strategy-based transfer pricing rule calculates a transfer price based on a pricing strategy, where a pricing strategy is a collection of one or more pricing rules that define an approach for achieving a specific goal associated with selling and pricing products, where the specific goal can be targeted at a pricing segment and/or a specific selling situation. The one or more rules can be defined in a pricing system, and the collection of the one or more defined rules can form a pricing strategy. More specifically, a pricing system allows a user to create one or more pricing strategies, where each pricing strategy can include one or more price lists, one or more currency conversion lists, one or more shipping charge policies, and/or one or more costs lists, that can be evaluated in a precedence-based manner to price items for a supply chain financial orchestration flow. The user can also set up one or more rules used by the pricing system to determine an applicable pricing strategy based on conditions, or qualifiers, such as the buy and sell terms, an item type, an item category, a supplier, a customer, etc. An appropriate pricing strategy can be determined and applied by the pricing system at a time of pricing a supply chain financial orchestration flow based on the rules set up in the pricing system.

Another option for defining a transfer pricing rule is a transaction cost-based transfer price option that defines a transaction cost-based transfer pricing rule. A transaction cost-based transfer pricing rule calculates a transfer price by applying a positive or negative markup over a cost incurred by a selling entity for an item or service (i.e., a transaction cost). The markup can be a standard markup, which can be specified as a percentage. The markup can be an advanced markup defined using one or more pricing term rules of a pricing system. A pricing term rule is a rule which defines how a price of an item or service can be adjusted or defined. For example, a product price adjustment term can have one or more qualifying conditions, which can be defined in a sale agreement or a promotion, for example. A pricing term rule can also determine a price of an item or service based on conditions or qualifies such as the buy and sell terms, an item type, an item category, a supplier, a customer, etc.

Another option for defining a transfer pricing rule is a source document price-based transfer price option that defines a source document price-based transfer pricing rule. A source document price-based transfer pricing rule calculates a transfer price by applying a positive or negative markup over a source document price, such as a purchase order price or a sales order price.

According to the embodiment, user interface 400 also includes multiple options criteria 420, where multiple options criteria 420 is a feature that enables a combination of multiple transfer pricing rules options. Thus, a transfer pricing rule can calculate a transfer pricing using multiple options, and thus, produce multiple transfer prices, and a transfer price can be selected from the multiple transfer prices. Based on a selection that the user makes within multiple options criteria 420, either a highest transfer price from the multiple transfer prices can be selected, or a lowest transfer price from the multiple transfer prices can be selected. For example, a transfer pricing rule can calculate both a transaction-cost based transfer price and a source document price-based transfer price, and select the highest price as the transfer price.

In one embodiment, a transfer pricing rule that is created using user interface 400 can be date effective. A date effective object (e.g., a date effective transfer pricing rule) is an object that has attributes whose values change over time. The date effective object can retain a complete history of all modifications and the time periods during which each modification is available for use in transactions. In other words, “date effective” allows users to make modifications to an object (e.g., transfer pricing rule) that can take effect in the future. Thus, for a date effective transfer pricing rule, any modifications to the date effective transfer pricing rule can be created with an effective date for the modification. Transactions associated with new source documents created after an effective date can utilize the modified transfer pricing rule to calculate a transfer price, while transactions associated with original source documents created before the effective date can utilize the original transfer price rule to calculate the transfer price. A supply chain financial orchestration system, when deriving the transfer pricing rules for calculating a transfer price, can retrieve the transfer pricing rules that are effective as of an effective date for a source document.

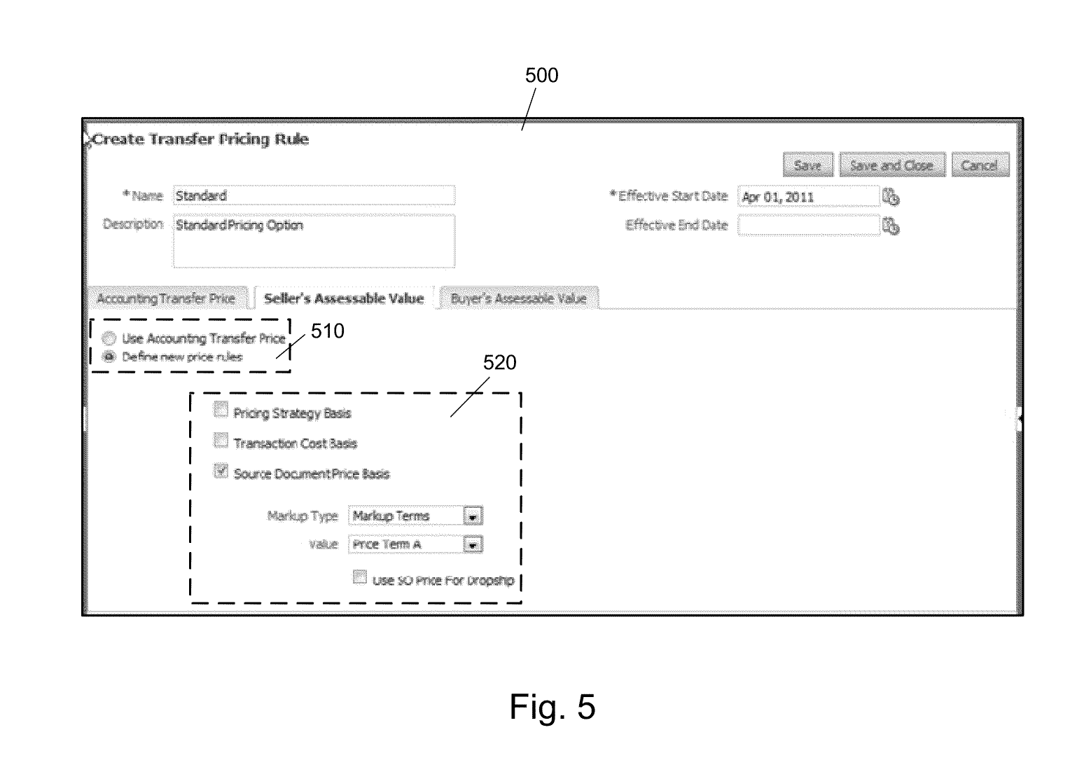

FIG. 5 illustrates another example user interface 500 for creating a transfer pricing rule, according to an embodiment of the invention. User interface 500 allows a user to define a transfer pricing rule, created using user interface 400 of FIG. 4, to calculate an assessable value for an internal transaction. An assessable value is the value of an internal transaction for tax calculation purposes. A separate assessable value can be calculated for a seller of the internal transaction, and a buyer of the internal transaction. While user interface 500 can allow the user to define the transfer pricing rule to calculate a seller's assessable value, a similar user interface can be displayed that allows the user to define the transfer pricing rule to calculate a buyer's assessable value.

According to the embodiment, user interface 500 includes assessable value calculation options 510. Assessable value calculation options 510 provide an option to either use a transfer price as an assessable value, or define a separate rule (or set of rules) to calculate the assessable value. If the option to define a separate rule (or set of rules) to calculate the assessable value is selected, then user interface 500 can also include assessable value rule options 520, where assessable value rule options 520 include one or more options for defining a rule to calculate the assessable value. Assessable value rule options 520 are similar to transfer pricing rule options 420 of FIG. 4, previously described.

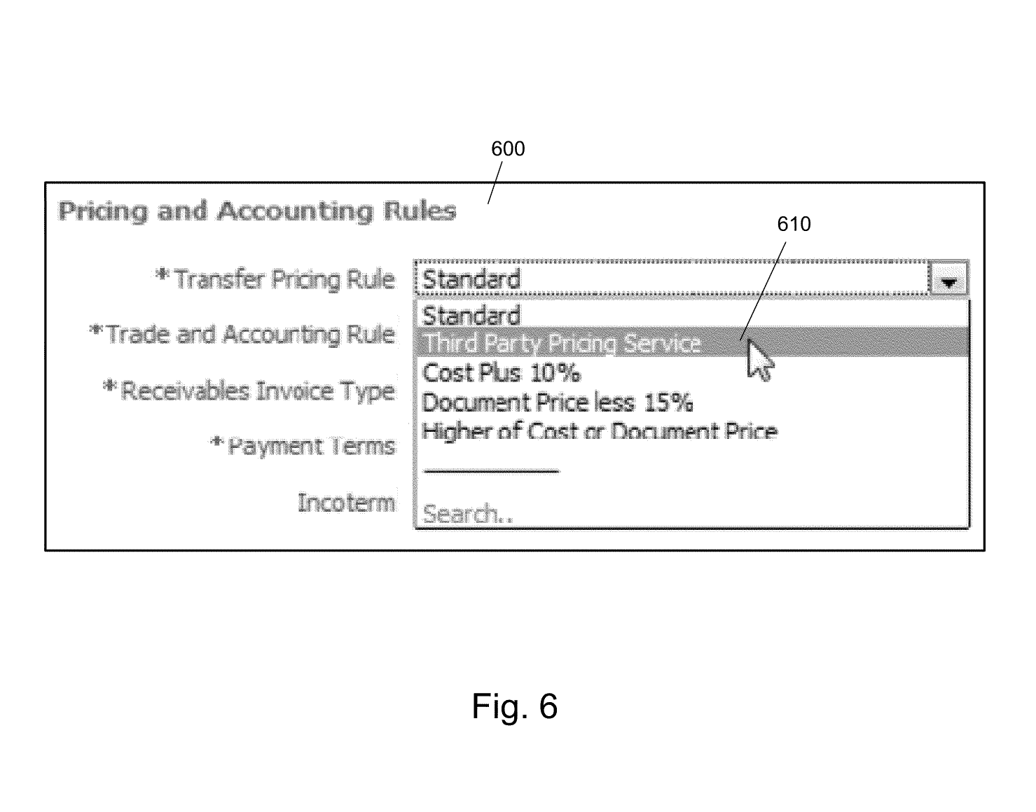

FIG. 6 illustrates an example user interface 600 selecting a transfer pricing rule from an external pricing system, according to an embodiment of the invention. According to the embodiment, another option for defining a transfer pricing rule is to define the transfer pricing rule as an external pricing service transfer pricing rule, where an external pricing service transfer pricing rule calculates a transfer price using an external pricing service of an external pricing system. According to the embodiment, by selecting third party pricing service option 610 within user interface 600, rather than selecting a transfer pricing rule defined using either user interface 400 of FIG. 4 or user interface 500 of FIG. 5, the transfer pricing rule can be defined to calculate a transfer price using an external pricing service of an external pricing system.

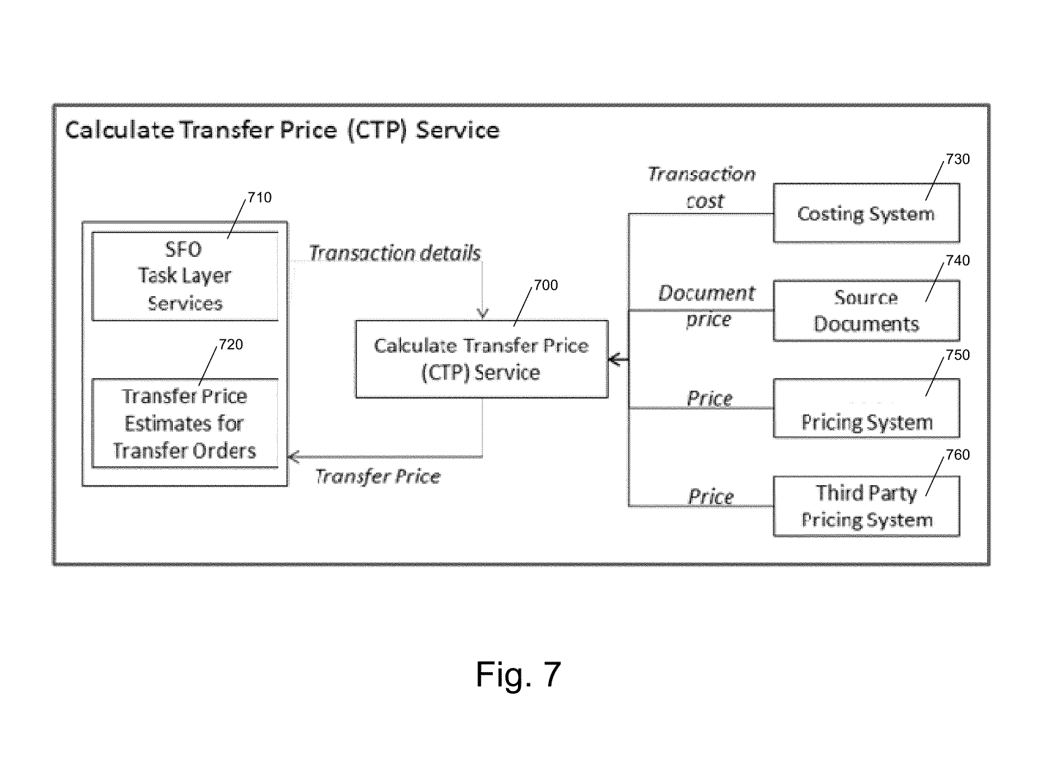

FIG. 7 illustrates a block diagram of a calculate transfer price service 700, according to an embodiment of the invention. Calculate transfer price service 700 is a web service that can be called when either a transfer price needs to be estimated, or an actual transfer price needs to be calculated for a given transaction. Thus, calculate transfer price service 700 can calculate a transfer price for one or more transactions of a supply chain financial orchestration system. Based on transaction information provided as input, and a transfer pricing rule configuration, calculate transfer price service 700 calculates the transfer price and provides the transfer price as output.

More specifically, as illustrated in FIG. 7, calculate transfer price service 700 can receive transaction information from supply chain financial orchestration task layer services 710. Calculate transfer price service 700 can further receive additional information depending upon a transfer pricing rule. Calculate transfer price service 700 can further use the received transaction information and the received additional information to produce a transfer price. Calculate transfer price service 700 can then provide the transfer price to a service 720 that either requires a transfer price estimate, or an actual transfer price for a transaction.

According to the embodiment, where a transfer pricing rule is a transaction cost-based transfer pricing rule, calculate transfer price service 700 can receive a transaction cost from costing system 730, and apply a markup to the received transaction cost to produce the transfer price. When a transfer pricing rule is a source document price-based transfer pricing rule, calculate transfer price service 700 can receive a document price from source documents 740, and can apply a markup to the received document price to produce the transfer price. When a transfer pricing rule is a pricing strategy-based transfer pricing rule, calculate transfer price service 700 can receive a pricing strategy from pricing system 750, and apply the received pricing strategy to the received transaction information to produce a transfer price. When a transfer pricing rule is an external pricing service transfer pricing rule, calculate transfer price service 700 can call an external pricing service of external pricing system 760 to produce a transfer price.

Calculate transfer price service 700 can be called in synchronous or asynchronous mode. Further, calculate transfer price service 700 can be called in quote mode when an estimation of a transfer price is required. In quote mode, calculate transfer price service 700 does not store the transfer price calculated for a transaction. When called in non-quote mode, calculate transfer price service 700 can store a transfer price calculated between two entities in a financial trade relationship for a specific source document. For subsequent calls made for a transfer price between the same financial trade relationship and same source document, the stored transfer price can be retrieved and returned.

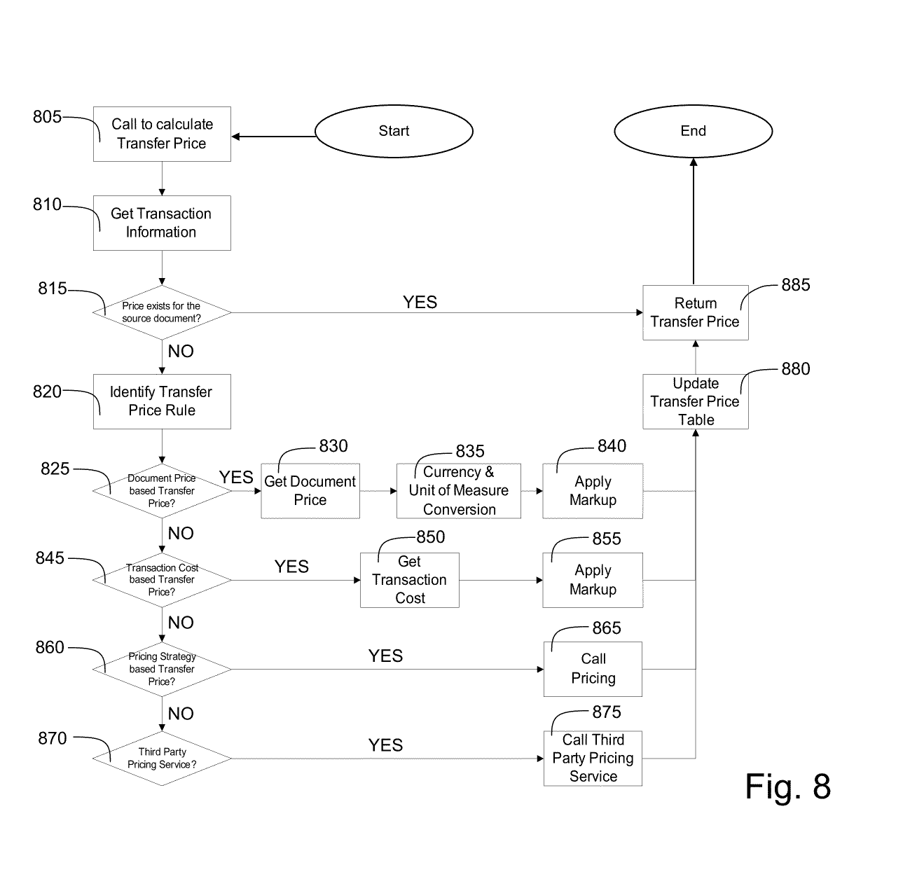

FIG. 8 illustrates a flow diagram of the functionality of a supply chain financial orchestration transfer pricing module (such as supply chain financial orchestration transfer pricing module 16 of FIG. 1), according to an embodiment of the invention. In one embodiment, the functionality of the flow diagram of FIG. 8 is implemented by software stored in memory or other computer-readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 805. At 805, a call is made to a calculate transfer price service (such as calculate transfer price service 700 of FIG. 7) to calculate a transfer price for a transaction. The call to the transfer price service can provide transaction information (i.e., information regarding the transaction). In certain embodiments, the transaction information can include a transaction identifier, a transaction date, an item identifier, a financial trade relationship identifier, and/or a source document identifier. A call to a calculate transfer price service can be either for an estimate of a transfer price, or for a calculation of an actual transfer price. The flow proceeds to 810.

At 810, the calculate transfer price service retrieves transaction information (i.e., information regarding the transaction). In certain embodiments, the transaction information can include a transaction identifier, a transaction date, an item identifier, a financial trade relationship identifier, and/or a source document identifier. Also, in certain embodiments, the calculate transfer price service can retrieve source document information (i.e., information regarding a source document associated with the transaction). In certain embodiments, the source document information can include a document price, a currency, a unit of measure, an item, an item category, a supplier, and/or a customer.

In certain embodiments, the calculate transfer price service also determines the effective dates, currency, and/or unit of measure in which the transfer price needs to be calculated. This can be specified in one or more document and accounting rules associated with the transaction. The currency of the transfer price can be user-defined. For example, the currency of the transfer price can be one of: a selling entity's accounting currency, a buyer entity's accounting currency, a source document's currency, or a user-defined currency. The flow proceeds to 815.

At 815, the calculate transfer price service determines whether a transfer price is already available in the currency and the unit of measure for the source document and the financial trade relationship. If a transfer price is already available, the flow proceeds to 885, where the transfer price is returned. If a transfer price is not already available, the flow proceeds to 820.

At 820, the calculate transfer price service identifies a transfer pricing rule. This is because a transfer price is required to be calculated using a transfer pricing rule if it is determined at 815 that a transfer price is not already available. The transfer pricing rule can be a transfer pricing rule that is defined for a financial trade relationship. The transfer pricing rule that is defined for the financial trade relationship can indicate a method and one or more rules used to calculate a transfer price. The flow proceeds to 825.

At 825, the calculate transfer price service determines whether the identified transfer pricing rule is a source document price-based transfer pricing rule. If the identified transfer pricing rule is a source document price-based transfer pricing rule, the flow proceeds to 830. Otherwise, the flow proceeds to 845.

At 830, the calculate transfer price service retrieves a document price. The flow then proceeds to 835.

At 835, the calculate transfer price service converts the document price to the transfer price currency and/or unit of measure if the document price is not available in the same currency and/or unit of measure as the transfer price currency. The flow then proceeds to 840.

At 840, the calculate transfer price service applies a markup to the document price to produce the transfer price. The markup can be a positive markup or a negative markup. Further, the markup can be a simple markup or an advanced markup. When the markup is an advanced markup, the calculate transfer price service can make a call to a pricing system to apply the markup based on one or more rules configured within the pricing system. The pricing system can allow a user to configure one or more rules to apply different markup values based on different transaction attributes. In certain embodiments, the transaction attributes can include a supplier, a customer, an item type, an item number, and/or an item category. The flow then proceeds to 880.

At 845, the calculate transfer price service determines whether the identified transfer pricing rule is a transaction cost-based transfer pricing rule. If the identified transfer pricing rule is a transaction cost-based transfer pricing rule, the flow proceeds to 850. Otherwise, the flow proceeds to 860.

At 850, the calculate transfer price service retrieves a transaction cost. The flow then proceeds to 855.

At 855, the calculate transfer price service applies a markup to the transaction cost to produce the transfer price. The markup can be a positive markup or a negative markup. Further, the markup can be a simple markup or an advanced markup. When the markup is an advanced markup, the calculate transfer price service can make a call to a pricing system to apply the markup based on one or more rules configured within the pricing system. The pricing system can allow a user to configure one or more rules to apply different markup values based on different transaction attributes. In certain embodiments, the transaction attributes can include a supplier, a customer, an item type, an item number, and/or an item category. The flow then proceeds to 880.

At 860, the calculate transfer price service determines whether the identified transfer pricing rule is a pricing strategy-based transfer pricing rule. If the identified transfer pricing rule is a pricing strategy-based transfer pricing rule, the flow proceeds to 865. Otherwise, the flow proceeds to 870.

At 865, the calculate transfer price service calls a pricing service of a pricing system to calculate the transfer price. In certain embodiments, by calling the pricing service, the calculate transfer price service selects a pricing strategy from one or more plurality of pricing strategies of the pricing system, where a pricing strategy includes one or more pricing rules. The calculate transfer price service further applies the pricing strategy to the received transaction information to produce the transfer price The flow then proceeds to 880.

At 870, the calculate transfer price service determines whether the identified transfer pricing rule is an external pricing service transfer pricing rule. If the identified transfer pricing rule is an external pricing service transfer pricing rule, then the flow proceeds to 875. If the identified transfer pricing rule is not an external pricing service transfer pricing rule, then in certain embodiments, the flow ends (not illustrated in FIG. 8). In alternate embodiments, if the identified transfer pricing rule is not an external pricing service transfer pricing rule, then the calculate transfer price service determines that the identified transfer pricing rule is another type of transfer pricing rule and applies the identified transfer pricing rule appropriately to calculate the transfer price (also not illustrated in FIG. 8).

At 875, the calculate transfer price service calls an external pricing service of an external pricing system to produce the transfer price. The flow then proceeds to 880. In certain embodiments, in addition to calculating the transfer price, the calculate transfer price service can also calculate an assessable value for both a buying entity and a selling entity. In certain embodiments, the calculate transfer price service can use the identified transfer pricing rule to calculate the assessable value for the buying entity and/or the selling entity. In other embodiments, the calculate transfer price service can use an alternate rule to calculate the assessable value for the buying entity and/or the selling entity.

At 880, if the call to the calculate transfer price service is for a calculation of an actual transfer price, the calculate transfer price service stores the transfer price (and optionally the assessable values) within a database. The storing can involve storing the transfer price (and optionally the assessable values) within a transfer price table of the database. This allows the transfer price to be retrieved for a subsequent transaction involving the same trade agreement relationship and the same source document. The flow then proceeds to 885.

At 885, the transfer price is provided to the service that called the calculate transfer price service. The flow then ends.

Thus, in one embodiment, a supply chain financial orchestration system can allow a user to choose from one or more transfer pricing options for calculating a transfer price for an internal transaction. The supply chain financial orchestration system can further calculate assessable values to determine taxable efficiency of tax-efficient supply chain models. Thus, the supply chain financial orchestration system can provide for a more robust calculation of transfer prices for internal transactions, which can lead to a more efficient supply chain flow for an entity.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to determine a transfer price based on a transfer pricing rule, the determining comprising:
receiving a request to calculate a transfer price for a transaction between a first entity and a second entity of a supply chain financial orchestration flow, wherein the supply chain financial orchestration flow defines a trade relationship between the first entity and the second entity;
receiving transaction information associated with the transaction;
selecting a transfer pricing rule from a plurality of transfer pricing rules, wherein the transfer pricing rule defines a rule to calculate a transfer price;
calculating the transfer price for the transaction based on the received transaction information and the selected transfer pricing rule; and
providing the transfer price.

2. The computer-readable medium of claim 1, wherein the transfer pricing rule comprises a source document price-based transfer pricing rule;
the determining further comprising:
receiving a document price of a source document;
receiving a currency and unit of measure; and
applying a markup to the document price using the currency and the unit of measure to produce the transfer price.

3. The computer-readable medium of claim 1, wherein the transfer pricing rule comprises a transaction cost-based transfer pricing rule;
the determining further comprising:
receiving a transaction cost; and
applying a markup to the transaction cost to produce the transfer price.

4. The computer-readable medium of claim 1, wherein the transfer pricing rule comprises a pricing strategy-based transfer pricing rule;
the determining further comprising:
selecting a pricing strategy comprising one or more pricing rules; and
applying the pricing strategy to the received transaction information to produce the transfer price.

5. The computer-readable medium of claim 1, wherein the transfer pricing rule comprises an external pricing service transfer pricing rule;
the determining further comprising:
calling an external pricing service to produce the transfer price.

6. The computer-readable medium of claim 1, wherein the supply chain financial orchestration flow comprises one of: an inter-company trade; or an intra-company trade.

7. The computer-readable medium of claim 1, the determining further comprising:
determining whether a transfer price has already been calculated for the transaction; and
providing the already-calculated transfer price rather than calculating a new transfer price.

8. The computer-readable medium of claim 1, the determining further comprising storing the transfer price.

9. The computer-readable medium of claim 1, the determining further comprising defining at least one pricing rule of the plurality of pricing rules to be one of: a source document price-based transfer pricing rule; a transaction cost-based transfer pricing rule; a pricing strategy-based transfer pricing rule; or a an external pricing service transfer pricing rule.

10. The computer-readable medium of claim 1, wherein the transaction information comprises at least one of:
a transaction identifier;
a transaction date;
an item identifier;
a financial trade relationship identifier; or
a source document identifier.

11. A computer-implemented method for determining a transfer price based on a transfer pricing rule, the computer-implemented method comprising:
receiving a request to calculate a transfer price for a transaction between a first entity and a second entity of a supply chain financial orchestration flow, wherein the supply chain financial orchestration flow defines a trade relationship between the first entity and the second entity;
receiving transaction information associated with the transaction;
selecting a transfer pricing rule from a plurality of transfer pricing rules, wherein the transfer pricing rule defines a rule to calculate a transfer price;
calculating the transfer price for the transaction based on the received transaction information and the selected transfer pricing rule; and
providing the transfer price.

12. The computer-implemented method of claim 11, wherein the transfer pricing rule comprises a source document price-based transfer pricing rule;
the computer-implemented method further comprising:
receiving a document price of a source document;
receiving a currency and unit of measure;
applying a markup to the document price using the currency and the unit of measure to produce the transfer price.

13. The computer-implemented method of claim 11, wherein the transfer pricing rule comprises a transaction cost-based transfer pricing rule;
the computer-implemented method further comprising:
receiving a transaction cost;
applying a markup to the transaction cost to produce the transfer price.

14. The computer-implemented method of claim 11, wherein the transfer pricing rule comprises a pricing strategy-based transfer pricing rule;
the computer-implemented method further comprising:
selecting a pricing strategy comprising one or more pricing rules; and
applying the pricing strategy to the received transaction information to produce the transfer price.

15. The computer-implemented method of claim 11, wherein the transfer pricing rule comprises an external pricing service transfer pricing rule;
the computer-implemented method further comprising:
calling an external pricing service to produce the transfer price.

16. A system, comprising:
a transfer price request reception module configured to receive a request to calculate a transfer price for a transaction between a first entity and a second entity of a supply chain financial orchestration flow, wherein the supply chain financial orchestration flow defines a trade relationship between the first entity and the second entity;
a transaction information reception module configured to receive transaction information associated with the transaction;
a transfer pricing rule selection module configured to select a transfer pricing rule from a plurality of transfer pricing rules, wherein the transfer pricing rule defines a rule to calculate a transfer price;
a transfer price calculation module configured to calculate the transfer price for the transaction based on the received transaction information and the selected transfer pricing rule; and
a transfer price provision module configured to provide the transfer price.

17. The system of claim 16, wherein the transfer pricing rule comprises a source document price-based transfer pricing rule;
wherein the transfer price calculation module is further configured to receive a document price of a source document;
wherein the transfer price calculation module is further configured to receive a currency and unit of measure; and
wherein the transfer price calculation module is further configured to apply a markup to the document price using the currency and the unit of measure to produce the transfer price.

18. The system of claim 16, wherein the transfer pricing rule comprises a transaction cost-based transfer pricing rule;
wherein the transfer price calculation module is further configured to receive a transaction cost; and
wherein the transfer price calculation module is further configured to apply a markup to the transaction cost to produce the transfer price.

19. The system of claim 16, wherein the transfer pricing rule comprises a pricing strategy-based transfer pricing rule;
wherein the transfer price calculation module is further configured to select a pricing strategy comprising one or more pricing rules; and
wherein the transfer price calculation module is further configured to apply the pricing strategy to the received transaction information to produce the transfer price.

20. The system of claim 16, wherein the transfer pricing rule comprises an external pricing service transfer pricing rule; and
wherein the transfer price calculation module is further configured to call an external pricing service to produce the transfer price.
